(19) United States
(12) Patent Application Publication
(10) Pub. No.: US 2013/0159875 A1
(43) Pub. Date: Jun. 20, 2013

(54) GRAPHICAL USER INTERFACE TO FACILITATE SELECTABLE PRESENTATION POINT OF MESSAGE LIST

(71) Applicants: Michael J. Ahiakpor, San Francisco, CA (US); Michael D. Schackwitz, Pleasanton, CA (US); Nathalie S. Collins, Palo Alto, CA (US)

(72) Inventors: Michael J. Ahiakpor, San Francisco, CA (US); Michael D. Schackwitz, Pleasanton, CA (US); Nathalie S. Collins, Palo Alto, CA (US)

(73) Assignee: MICROSOFT CORPORATION, Redmond, WA (US)

(21) Appl. No.: 13/325,080

(22) Filed: Dec. 14, 2011

(51) Int. Cl. G06F 3/048

(52) U.S. Cl. 715/752

(57) ABSTRACT

Techniques for navigating to a point in a presented list displayed on a display. One representative technique includes sorting a message list presented on the display based on at least one sorting criterion designated via a graphical user interface. A graphical selector control having a plurality of graphically selectable access points is presented, based on the designated sorting criterion. When a graphically selectable access point is selected, the presentation of the message list on the display device is adjusted to a position corresponding to the graphically selected access point.

### BACKGROUND

Electronic computing and communication devices are typically equipped to communicate electronic messages, such as electronic mail (e.g. “email”), text messages, or the like. A wide variety of computing and/or communication devices can receive or transmit communications, such as desktop computing devices, laptop and other portable computers, smartphones and other hand-held devices, as well as other electronic devices. These devices typically provide a visual display to present the list of the communications, as well as individually selected communication items. Communication or other digitally-provided lists may be lengthy, at least with respect to the portion of the list that can reasonably be presented on the display or in a display window. Thus, it is common for these devices to manage lists that cannot be presented in their entireties.

Local user applications can generate lists of information for local presentation. Further, locally or remotely hosted user applications may receive digital information that is presented locally by way of a list. For example, a user's email may include an inbox folder, a sent items folder, deleted items folder, etc. The communications listed in each of these folders often include too many list entries to fully present the list on a display. To view other items not currently in view, a user may scroll through the list to gain access to other list items, or perform a search for the desired item.

However, users sometimes want to find a list item, but do not have sufficient information to conduct a search for the item. For example, in the context of email messages, a user may have forgotten who sent a particular email(s) that the user remembers receiving, may have forgotten the spelling of a sender's name, etc. A sender may use a display name different from his/her actual name, which may also be difficult for the recipient to later remember in order to search for it. The user may also forget terms or keywords that could be searched in the email, or the terms are too generic to provide focused search results. Simply stated, there are numerous situations where searching an inbox or other list serves as an insufficient manner of locating an item. Users may browse for the email or other list item, but this can be a difficult endeavor, particularly where the list is lengthy.

### SUMMARY

Techniques for navigating to a point in a presented list displayed on a display. One representative technique includes sorting a message list presented on the display based on at least one sorting criterion designated via a graphical user interface. A graphical selector control having a plurality of graphically selectable access points is presented, based on the designated sorting criterion. When a graphically selectable access point is selected, the presentation of the message list on the display device is adjusted to a position corresponding to the graphically selected access point.

In another particular implementation of such a technique, an apparatus is provided that includes at least a display, a user interface, and a processor. In one embodiment, a user interface is configured to facilitate selection of a graphical selector control having graphically selectable access points relating to a message field of messages in a message list. The user interface may be further configured to facilitate selection of a graphically selectable access point(s) for the message field. A processor is configured to adjust the presentation of the message list on the display to a position corresponding to the selected graphically selectable access point and sorted by the message field.

Another representative implementation involves computer-readable media (any one or more storage devices) having instructions stored thereon that are executable by a processor. The computer-executable instructions perform functions including sorting an email list presented on a display based on a receive date of each email in the email list, and receiving an indication to invoke a graphical calendar selector control. In response to receiving the indication, the graphical calendar selector control is presented using a vertically-navigable, month-to-month calendar with graphically selectable dates. A selection indication is received for a selected one of the graphically selectable dates, and the presentation of the email list on the display is adjusted to present an email corresponding to the selected graphically selectable date at the top of the presented email list.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram depicting a representative technique for facilitating selectable presentation points in a message list;

FIGS. 2A and 2B illustrate alternative representative embodiments of graphical user interface systems implementing list access techniques described herein;

FIGS. 3A-3C are block diagrams illustrating representative alternative embodiments for sorting message lists and adjusting list presentations based on selectable access points;

FIG. 4 depicts representative selector controls including associated control access points that may be used to readjust presentation of a list on a display;

FIG. 5 is a flow diagram depicting a computer-implemented method for facilitating a selectable presentation point in a message list in accordance with the disclosure;

FIG. 6 is a flow diagram depicting a computer-implemented method for facilitating a selectable presentation point in a message list, where sorting is inherently performed in connection with selection of a list access point selector;

FIG. 7 is a flow diagram depicting a computer-implemented method for facilitating a selectable presentation point in a message list based on a calendar date;

FIG. 8 is a flow diagram depicting a computer-implemented method for facilitating a selectable presentation point in a message list based on an alpha character;

FIG. 9 is a block diagram of a representative apparatus facilitating a selectable presentation point in a message list in accordance with the disclosure; and

FIG. 10 depicts a representative computing system in which principles described herein may be implemented.

### DETAILED DESCRIPTION

In the following description, reference is made to the accompanying drawings that depict representative implementation examples. It is to be understood that other embodiments and implementations may be utilized, as structural and/or operational changes may be made without departing from the scope of the disclosure.

The disclosure is generally directed to techniques for navigating to a desired point in a viewable electronic list. In one embodiment, a graphical user interface conditionally presents a plurality of selectable presentation points associated with a message list. This facilitates user identification of previously-received communication items in a message list, or other items in a list.

As noted above, lists such as email or other message lists are often lengthy, relative to a portion of the list that can reasonably be presented on the device's display. To view a particular list item, the user can scroll through or otherwise navigate the list, or can attempt to search for the item(s) using search terms. Scrolling through the list to locate a desired list item can be difficult and time-consuming Items may be searched for, but it is often the case that the user has insufficient information to conduct a search for the item. The user may have forgotten the sender's name or spelling, forgotten specific words used, etc. Thus, searching is sometimes an inadequate option in certain instances.

Techniques described herein facilitate list browsing, while reducing the portion of the list to be browsed. In the context of email message lists, graphical selectable controls are presented when targeted browsing is desired. The graphical selectable controls provide graphically selectable access points at various locations within the message list, to enable the user to reach a discernable portion of the message list in which to browse.

In one embodiment, a message list may be sorted for viewing on a display, where the sorting is based on some criteria such as date of message receipt, sender's name, subject, etc. A graphical selector control having graphically selectable access points that relate to the sorting criteria may be presented. When the user selects a graphically selectable access point(s), the presentation of the message list can be adjusted to a position corresponding to the graphically selected access point.

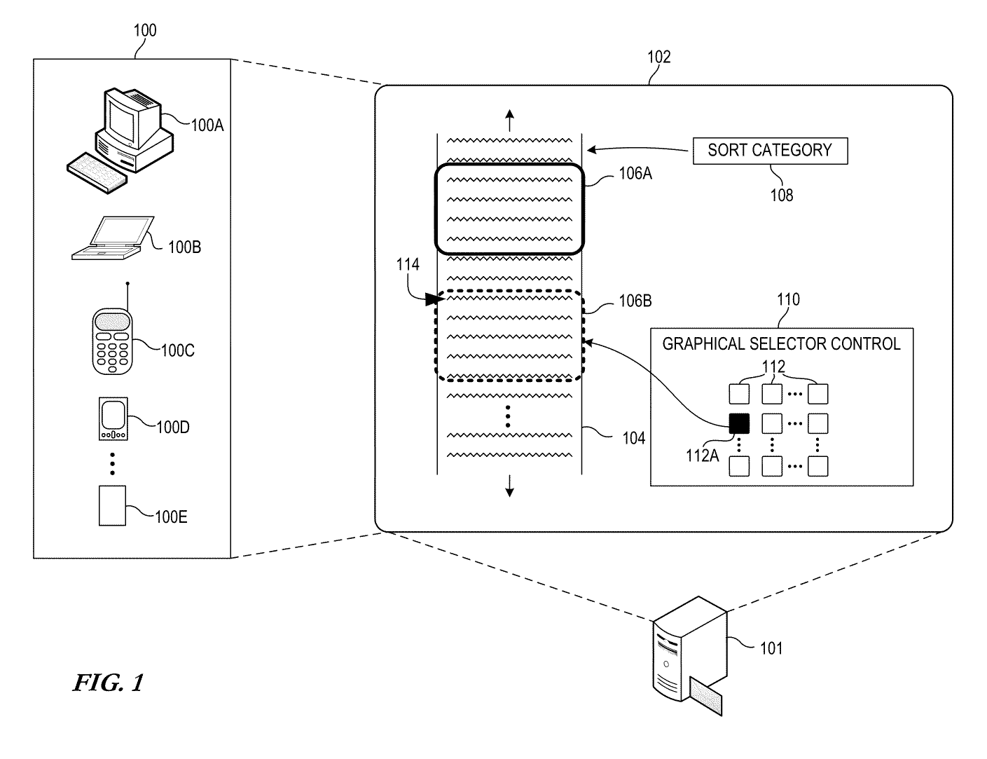

FIG. 1 is a block diagram depicting a representative technique for facilitating selectable presentation points in a message list. The techniques may be utilized in any device 100 including a display 102, such as a desktop computer 100A, laptop or other portable computer 100B, smart phone or mother mobile phone 100C, personal digital assistant 100D, or other electronic device 100E that may provide at least a display (e.g. appliances, automobile, etc.). Additionally, processing and user interface functions may be hosted on a remote device, such as a web-based email server 101 or other network-accessible system. For example, a web-based email server 101 may perform the functions and host the relevant user interface mechanisms for display on the client device 100. In other embodiments, such as where a local email application is resident at the device 100, the processing and user interface functions may be provided on the client device 100 itself.

The display 102 is depicted as presenting a list 104, such as a list of emails or other messages received by the user of the device 100. For purposes of example, it is assumed that only a portion of the list 104 is presented on the display 102, represented by the display area 106A. In other words, for a complete email list 104, a portion of the list is presented in the display area 106A, which may consume any part or all of the visible display 102.

In order to browse a potentially more pertinent subsection of the list 104, the presentation of the list 104 may be adjusted to present a different portion of the list, as depicted by display area 106B. In one embodiment, the user first sorts the list 104, such as by activating a sort category 108 user interface (UI) item. For example, a selectable button, icon, link or other UI item represent the sort category 108 UI item, which enables the list 104 to be sorted by that category. As a more particular example, a date button may be selected to sort the list 104 by date.

Either automatically in response to sorting, or in response to other UI action(s) or triggering event, a graphical selector control 110 is presented. In one embodiment, the graphical selector control 110 serves as a graphical list navigation control to enable navigation to one of a plurality of control access points 112 in the list 104. For example, selection of control access point 112A may navigate to a list access point 114, such as a particular message in the list 104, now viewed via display area 106B.

As a more particular example, the sort category 108 may involve a sort “by date,” such that the graphical selector control 110 includes a plurality of calendar dates representing the control access points 112. Control access point 112A might represent, for example, a date of Jan. 10, 2011, in which case the list access point 114 includes a message at or nearest the selected date. The display area 106B presents the portion of the sorted list 104 including the selected date. Using a graphical selector control 110 in this manner, the user can jump to an intermediary part of the message list 104, thereby focusing the browsing actions based on the selected control access point 112.

The graphical selector control 110 may be presented in response to selection of a sort category 108, in response to invoking a particular UI item such as a button or link (not shown), and/or the like. The graphical selector control 110 may be presented until a selection is made, or until some other event occurs. For example, the graphical selector control 110 may be presented for a limited time and then become inactive. In another embodiment, it may “fade” in as the user's cursor nears a screen 102 location and fade out as the cursor moves away. The graphical selector control 110 may be presented in a designated location on the screen 102, or in a conditional manner such as proximate the cursor location, proximate an activation button/link, proximate the list 104, etc. These are merely representative examples, as the manner, duration and other characteristics of the graphical selector control 110 may vary based on the particular implementation.

If the user has navigated to the beginning of the message list 104, and would otherwise see a partial page based on where the message list portion 114 would begin, in one embodiment the presentation is not displayed as a partial page. Rather, the presentation may be reset to a full page, with the message(s) that comply with the selected control access point 224 presented at a position in the message list portion 114 other than at a boundary (e.g. other than at the top or bottom of the message list portion 114). The message(s) associated with the selected date may be presented in a distinguishable manner from other presented messages. In another embodiment, if there are not enough messages to fill a page after the message list portion 114 has been adjusted in view of a selected control access point 112, a partial page may be presented. For example, if there are not enough messages to fill a page after a jump to a specified alphabet range has been made, a partial page may be presented. A representative exception to such a rule may be where the user has navigated to the beginning of the message list, where the user may be presented with a fully page rather than a partial page.

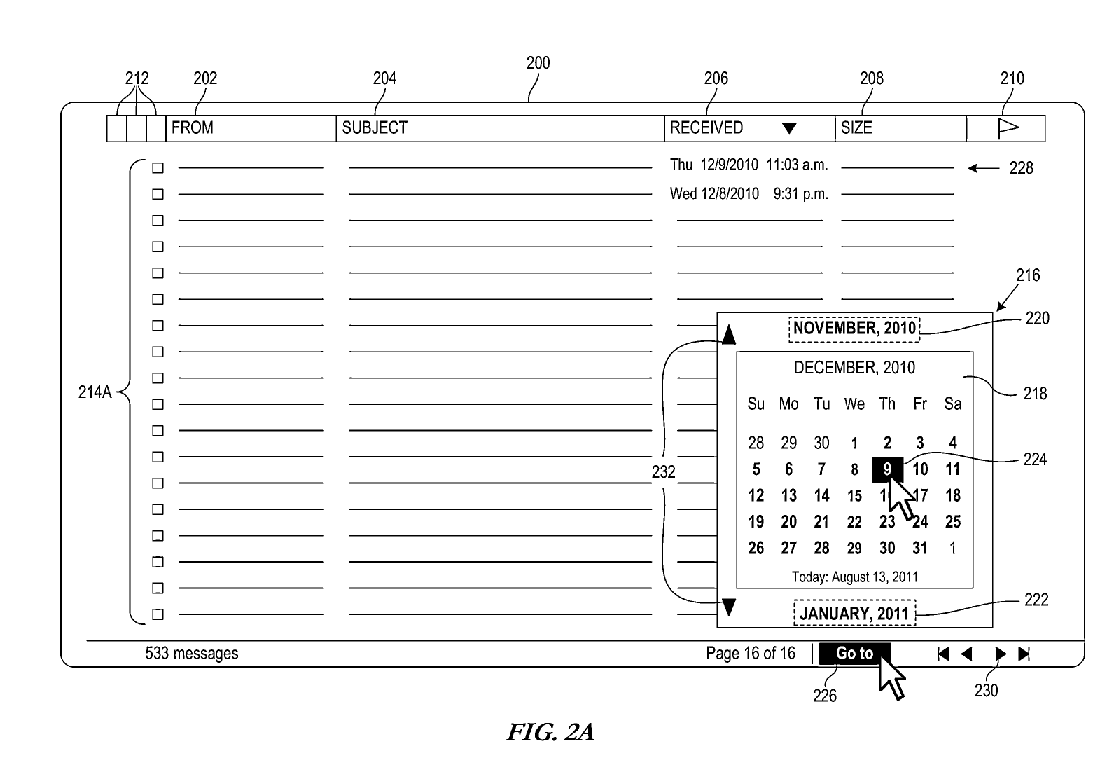

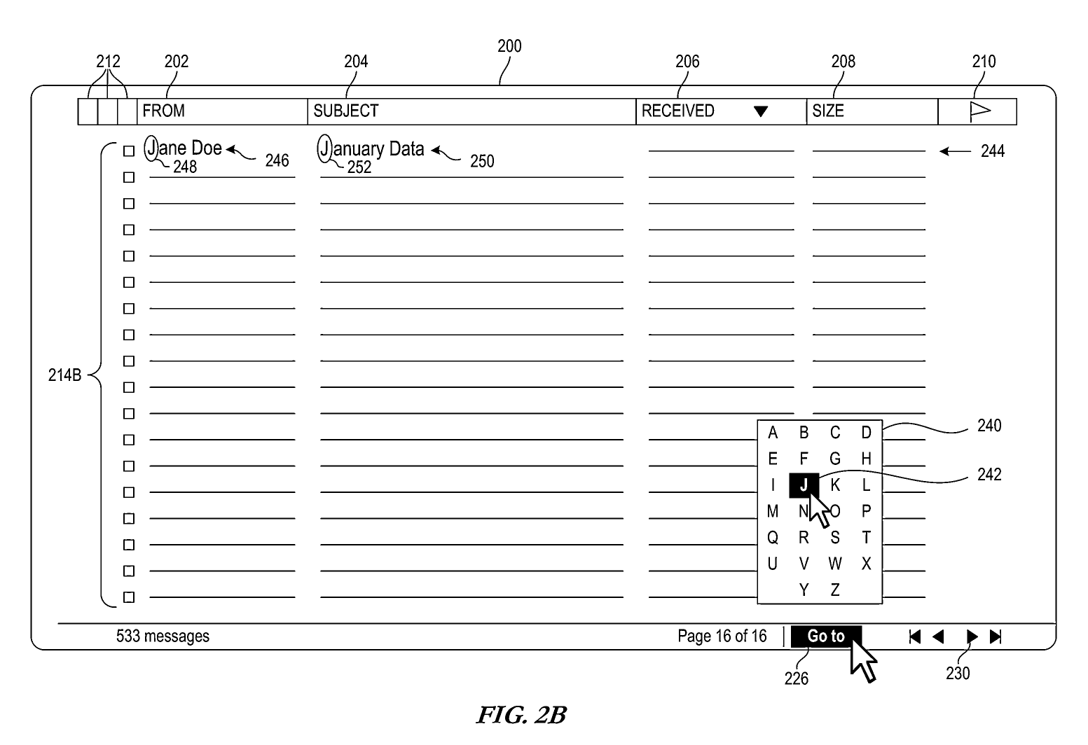

FIGS. 2A and 2B illustrate alternative representative embodiments of graphical user interface (GUI) systems implementing list access techniques described herein. As FIGS. 2A and 2B illustrate alternative embodiments relative to a common GUI screen 200, like reference numbers are used for FIGS. 2A and 2B where appropriate.

FIG. 2A illustrates a representative graphical user interface (GUI) screen 200 presenting a user's email inbox, where message list browsing is focused by date. The email application used to present the screen 200 may be a local application resident on the user device, or may be a remotely accessed application such as a web-based application accessed by the user device via one or more networks. The email inbox screen 200 may include any one or more fields, such as the “from” field 202, “subject” field 204, “received” field 206, “size” field 208, “flag” field 210, etc. Any of these and/or other fields 212 may be used to sort the presented list portion 214A. For example, clicking the received field 206 can sort the list, and thus the presented list portion 214A, by ascending or descending date/time.

In one embodiment, selecting a date sort function by selecting the received field 206 can automatically present the calendar selector control area 216. The calendar selector control area 216 can thus pop up or otherwise be revealed in response to invoking a sort function, which is the date sort function in this example. In one embodiment, an option to present the calendar selector control area 216 in response to invoking a date sort function could be set in an options designator associated with the local or remote email application. Other triggering functions may alternatively be used instead of invoking a sort field.

In another embodiment, the calendar selector control area 216 is presented in response to an explicit action taken by the user. For example, a button, link, checkbox, menu item and/or other UI mechanism may be available for selection by the user, where selection thereof presents the calendar selector control area 216 (or other selector control area in other embodiments). In the illustrated embodiment, a “Go to” button 226 can be selected (e.g. clicked on) to invoke the calendar selector control area 216.

In one embodiment, selection of the button 226 will present a selector control area that is associated with the currently-selected sort field. For example, where the received field 206 has been selected, selection of the button 226 will present a date-based selector control area, such as the calendar selector control area 216. On the other hand, if the subject field 204 had been selected, in one embodiment selection of the button 226 may present an alpha selector control area enabling the user to pick a letter or a letter range in which to adjust the presented list portion 214A. In yet another embodiment, one or more buttons 226 or other UI items may be provided, where each is associated with a particular sort function to automatically sort the list and provide the appropriate selector control area. For example, selection of the Go to button 226 may be associated with a date field, such that the list will be sorted by date, and the calendar selector control area 216 will be presented for date selection. In one embodiment, such one or more buttons 226 may be served by the UI items corresponding to the fields 202, 204, 206, etc., whereby the appropriate selector control area is presented depending on the sort field that was selected.

When a calendar selector control area 216 has been presented, the user can scroll or otherwise navigate through months and years, as depicted by concurrent months/years 218, 220, 222 in the illustrated example. From a particular timeframe shown via the calendar selector control area 216, the user can select a particular date, or even a range of dates. This may be helpful where, for example, a user remembers receiving an email(s) regarding a subject, but cannot remember who sent the email or any relevant keywords contained therein. The user may remember an approximate timeframe in which the email was received. The user can more accurately focus his/her message browsing for the desired email(s) by navigating to and selecting an approximate date using the calendar selector control area 216, which readjusts the presented list portion 214A to include the selected date. This serves as a focused date browsing tool. Thus, in general, the focused message list browsing feature is based on identifying at least one constituent of a selected (or default) sort category, thereby enabling the user to search a more relevant subset of the entire list.

In the illustrated embodiment, the user has navigated to the date of Dec. 9, 2010, depicted by highlighted date 224. By selecting the date 224, the list is readjusted to present a presented list portion 214A that may begin at, or otherwise include, the date 224. For example, the selected date 224 may be presented on a top line 228 of the presented list portion 214A. Since the presented list portion 214A is presented in descending date order, e-mails or other messages in the list that are older than the selected date 224 will be presented underneath the top line 228. Alternatively, if the presented list portion 214A was presented in ascending date order, then messages newer than the selected date 224 will be presented underneath the top line 228. It should be recognized, however, that the selected date 224 may be presented at locations other than the top line 228 of the presented list portion 214A, and other messages would be displayed accordingly depending on whether the presented list portion is in ascending or descending date order. It should also be noted that other dates may be used in the analysis, such as a first date of an email “conversation,” which may include one or more emails at dates other than the selected date 224.

In one embodiment, the calendar selector control area 216 is presented in a vertical orientation. Thus, when presented in month view, month-to-month navigation is effective in a top-down and/or bottom/up fashion. While this orientation may be used for any purpose, it can address a directional conflict with left/right navigational directions associated with advancing or moving backwards in the message list. For example, clicking a right arrow 230 moves the presented list portion 214A one page forward in the list, having left/right arrows to navigate the calendar selector control area 216 may be confusing, as it can become unclear which navigational arrow is associated with which feature. A vertically oriented calendar selector control area addresses this issue. For example, the user can select an appropriate navigational arrow 232 to move vertically from month-to-month, can select a previous or subsequent month via UI items for months/years 220, 222, can scroll up or down using keyboard, mouse or other scrolling hardware, etc.

Other fields may similarly be used to sort and readjust the presented list portion 214A, such as the from field 202, subject field 204, size field 208, flag field 210, icon, attachment, and/or other fields 212, etc. The description of FIG. 2A is equally applicable to such other fields. One such example is shown in FIG. 2A, which illustrates a representative GUI screen 200 presenting a user's email inbox, where message list browsing is focused by alpha characters.

In one embodiment, selecting a field that is sorted by alpha characters (e.g. from field 202, subject field 204, etc.) can automatically present the alpha selector control area 240. For example, the alpha selector control area 240 can pop up or otherwise be revealed in response to invoking an alpha sort function, such as a “from” or “subject” sort function. In one embodiment, an option to present the alpha selector control area 240 in response to invoking an appropriate alpha sort function could be set in an options designator associated with the local or remote email application. Other triggering functions may alternatively be used instead of invoking a sort field.

In another embodiment, the alpha selector control area 240 is presented in response to an explicit action taken by the user. For example, a button, link, checkbox, menu item and/or other UI mechanism may be available for selection by the user, where selection thereof presents the alpha selector control area 240. In the illustrated embodiment, the “Go to” button 226 can be selected (e.g. clicked on) to invoke the alpha selector control area 240.

As a more particular example, the user may select a particular letter, or range of letters, presented via the alpha selector control area 240. In a first embodiment, it is assumed that the “from” field 202 is used to sort the list, and that the user has selected the letter(s) 242, which in the illustrated embodiment is the letter “J.” By selecting this letter 242, the list is readjusted to present a presented list portion 214B that may begin at, or otherwise include, messages from senders beginning with the letter “J.” For example, the selected letter 242 may present messages in the from field 202 beginning on a top line 244 of the presented list portion 214B, from senders 246 that begin with the letter “J” 248. If the presented list portion 214B is presented in descending alphabetic order, emails or other messages in the list from senders alphabetically prior to the selected letter 242 will be presented underneath the top line 244. If the presented list portion 214B was presented in ascending alphabetic order, then messages from senders alphabetically following the selected letter 242 will be presented underneath the top line 244. It should be recognized, however, that the messages readjusted by the selected beginning letter(s) 242 may be presented at locations other than the top line 244 of the presented list portion 214B, and other messages would be displayed accordingly depending on whether the presented list portion is in ascending or descending order.

In another example, the user may select a particular letter, or range of letters, to jump to a portion of the list based on a different alpha field. For example, the “subject” field 204 may be used to sort the list, where the user can select a letter(s) 242. By selecting the letter 242 (“J” in this example), the list is readjusted to present a presented list portion 214B that may begin at, or otherwise include, messages having a subject field beginning with the letter “J.” For example, the selected letter 242 may present messages beginning on the top line 244 of the presented list portion 214B, for messages having subject lines 250 beginning with the letter “J” 252. If the presented list portion 214B is presented in descending alphabetic order, emails or other messages in the list having subject lines alphabetically prior to the selected letter 242 will be presented underneath the top line 244. If the presented list portion 214B was presented in ascending alphabetic order, then messages having subject lines alphabetically following the selected letter 242 will be presented underneath the top line 244. Messages readjusted by the selected beginning letter(s) 242 may be presented at locations other than the top line 244 of the presented list portion 214B, and other messages would be displayed accordingly depending on whether the presented list portion is in ascending or descending order.

Users may select letters by clicking on the presented letter(s), using voice recognition, etc. In one embodiment, the user clicks on a single letter to identify the letter from which the list will be readjusted. In another embodiment, the user can select multiple letters, where the list will present those alpha fields beginning with the selected letters (e.g. in the event the user is unsure whether a person's name is in first/last or last/first format).

Still other fields may be used to readjust the presented list portion 214B. For example, the size field 208 may present a size selector control area (not shown), where message size thresholds or ranges are presented for selection. The flag field 210 can present a flag selector control area (not shown), where flag types, colors, reminder dates and/or other distinguishable criteria may be presented for selection. These and other selector control functions may be implemented in accordance with the techniques described herein.

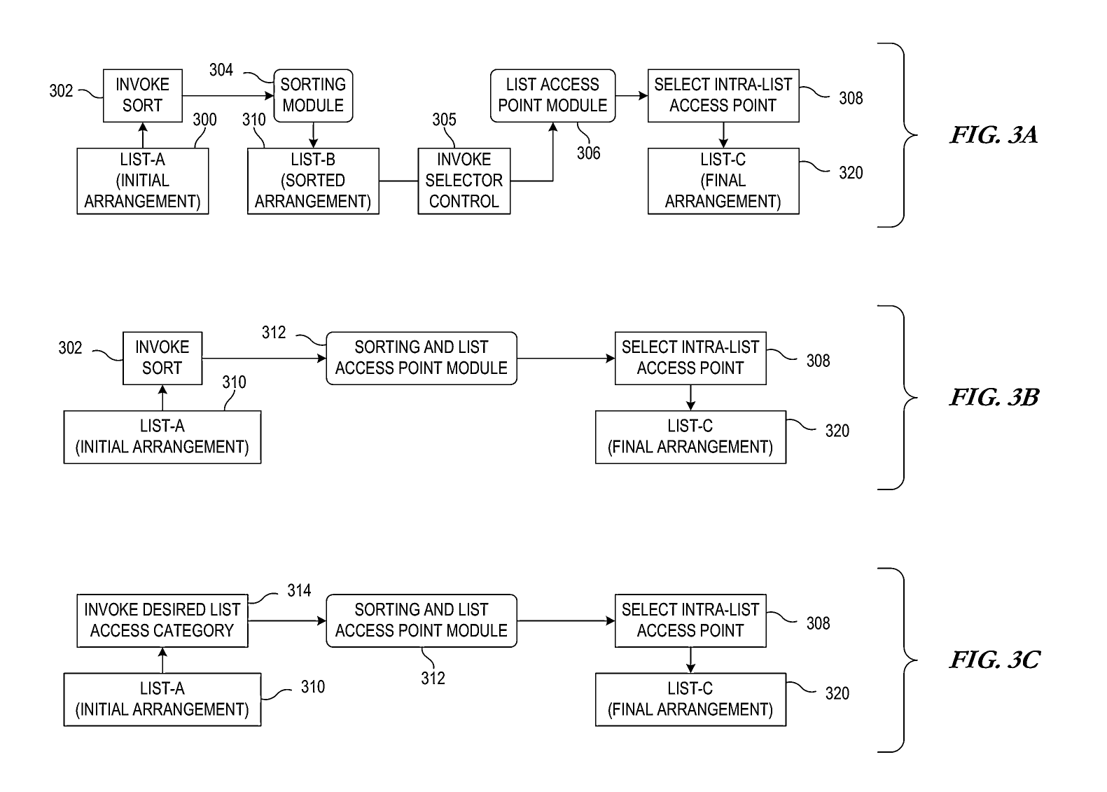

As previously noted, different embodiments involve manual sorting, automatic sorting, manual and automatic selection of list adjustment mechanisms, etc. FIGS. 3A-3C are diagrams depicting alternative representative examples of such features. Where appropriate, like reference numbers are used for like items in FIGS. 3A-3C.

Referring first to FIG. 3A, an initial arrangement of the message list, particularly the presented portion of the list, is shown as list-A 300. In the embodiment of FIG. 3A, a sort function can be invoked as depicted at block 302. A sorting module 304 performs the sort invoked at block 302. The sorting module 304 may be implemented, for example, using software executable by a processor, and/or other circuitry. The result is a sorted arrangement of the list, shown as list-B 310. The user can explicitly invoke a selector control, as depicted at block 305, such as by clicking on or otherwise selecting a UI feature that presents the selector control. A list access point module 306 can recognize the selection from block 305, and present the appropriate selector control with the associated control access points. Upon user selection at block 308 of a control access point (e.g. date, letter, etc.), a resulting arrangement of the list portion is presented, depicted as list-C 320 in this example. Thus, the embodiment of FIG. 3A assumes that the user is in control of both invoking the sorting function, and invoking the selector control if and when desired.

FIG. 3B relates to an embodiment where the selector control is automatically presented in connection with performing a sort function. For example, the sort function can be invoked as depicted at block 302. In this embodiment, a sorting and list access point module 312 recognizes the initiation of a sort function, and in response automatically presents a selector control UI from which the user can select an intra-list access point as shown at block 308. Upon user selection at block 308 of a control access point (e.g. date, letter, etc.), a resulting arrangement of the list portion is presented, depicted as list-C 320 in this example. Thus, the embodiment of FIG. 3B assumes that the selector control is automatically presented in connection with initiation of a message field sort function.

FIG. 3C relates to yet an embodiment where the sorting function is inherent to the selector control, of one or more available selector controls, that is invoked. For example, the user may invoke a desired list access category as shown at block 314, such as requesting presentation of access points for a “from” field, “subject” field, “received” (e.g. date) field, etc. In this embodiment, the sorting and list access point module 312 recognizes the selection of a selector control, and in response automatically presents a selector control UI from which the user can select an intra-list access point as shown at block 308. In this embodiment, the sorting will be automatically performed based on the particular access category identified by the user. Upon user selection at block 308 of a control access point (e.g. date, letter, etc.), a resulting arrangement of the list portion is presented, depicted as list-C 320. Thus, the embodiment of FIG. 3C assumes that the selector control is presented in response to the user's selection of a selector control, where sorting is performed without the list being first sorted by an explicit identification by the user of the field to sort.

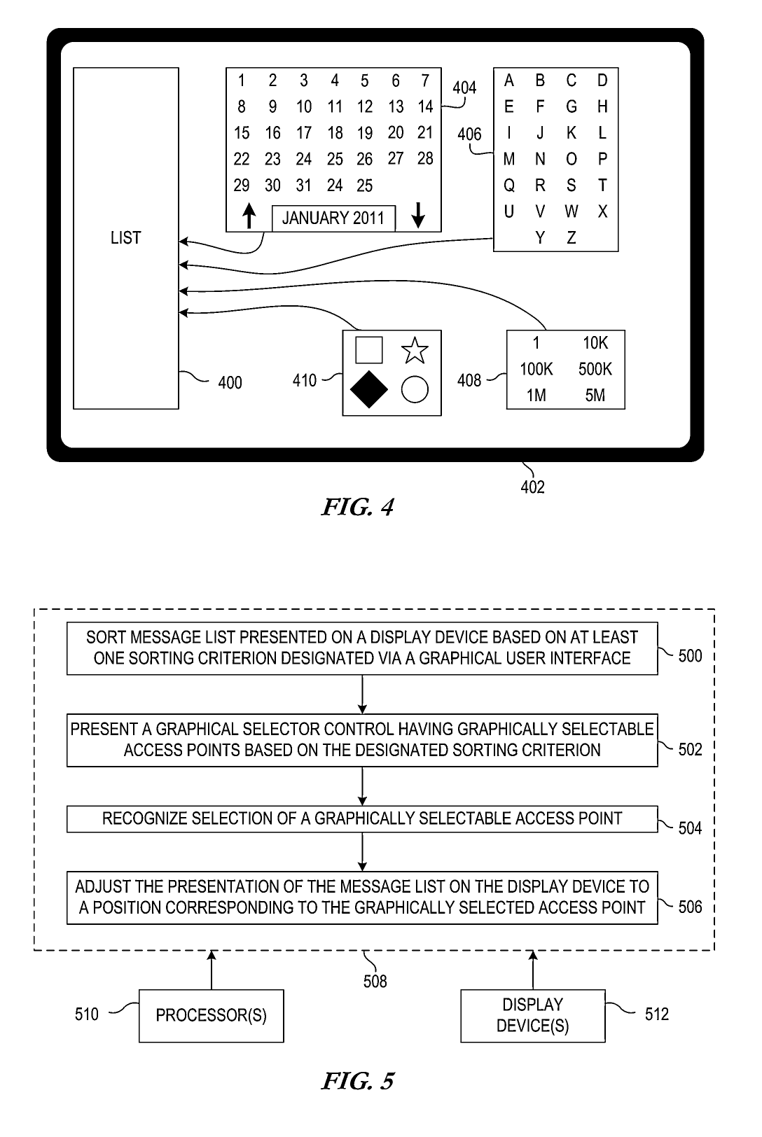

As noted above, any desired field(s) may be used to readjust the presented list portion. FIG. 4 depicts representative selector controls including associated control access points that may be used to readjust presentation of a list 400 on a display 402. The calendar selector control area 404 enables the viewable portion of the list 400 to be adjusted to present the list 400 at a date, or nearest date, selected via the calendar selector control area 404. The alpha selector control area 406 enables the viewable portion of the list 400 to be adjusted to present it from a letter(s), or nearest letter, selected via the alpha selector control area 406. Cs another example, the message size selector control area 408 enables the viewable portion of the list 400 to be adjusted to present the list 400 from the message size, or nearest message size, selected via the message size control area 408. As yet another example, the icon selector control area 410 enables the viewable portion of the list 400 to be adjusted to present the list 400 from a message type selected via the icon selector control area 410. These are merely representative examples, as selector control functions may be implemented for any desired message field in which list segments can be differentiated.

FIG. 5 is a flow diagram depicting a computer-implemented method for facilitating a selectable presentation point in a message list in accordance with the disclosure. In this embodiment, at block 500, a message list presented on a display device 512 is sorted, based on at least one sorting criterion designated via a graphical user interface. At block 502, a graphical selector control is presented, having graphically selectable access points based on the designated sorting criterion. Selection of a graphically selectable access point(s) is recognized at block 504, and at block 506, the presentation of the message list is adjusted on the display device 512 to a position corresponding to the graphically selected access point.

In one embodiment, such a computer-implemented method is implemented using software instructions, such that the various features collectively represent an operable module 508 when executed via a processor 510. Individual features may also be represented by operable modules. For example, the feature at block 500 may be implemented in software executable by the processor 510 to provide a message list sorting module. Similarly, the feature at block 502 may be implemented in software executable by the processor 510 to provide a selector control presentation module; the feature at block 504 may be implemented in software executable by the processor 510 to provide an access point recognition module; and the feature at block 506 may be implemented in software executable by the processor 510 to provide a message list adjustment module. Such computer-implemented features enable a computing and/or communication device to operate as a specific purpose device to perform functions as set forth in the present disclosure.

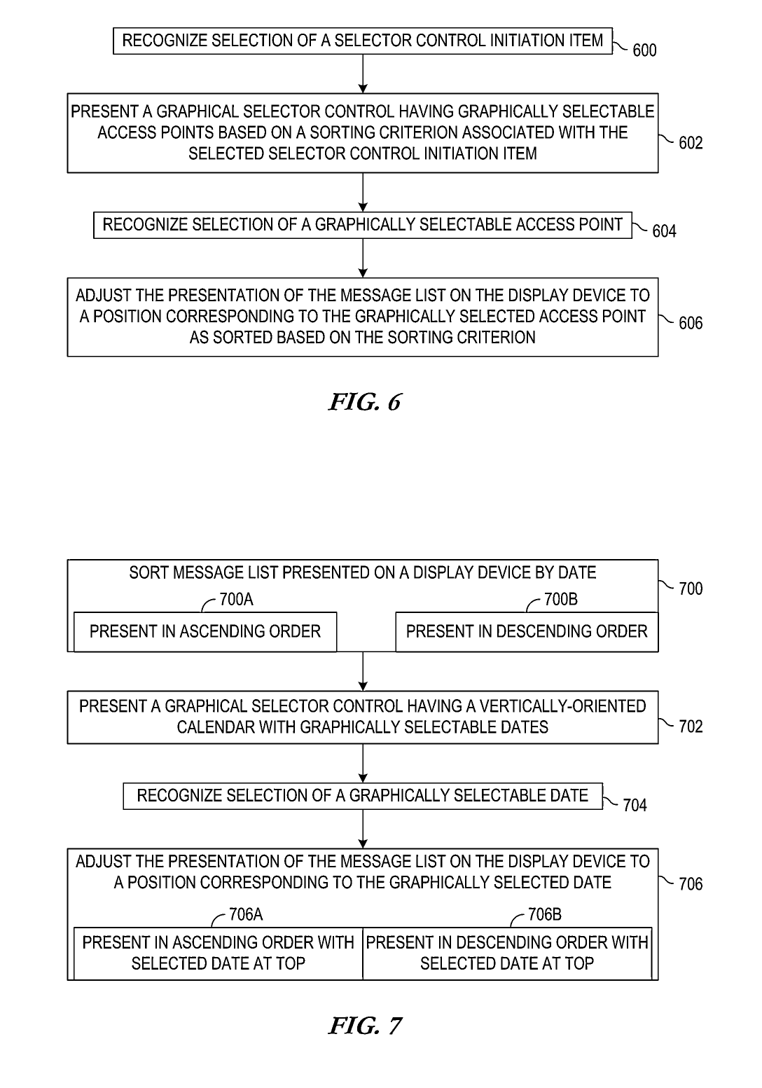

FIG. 6 is a flow diagram depicting a computer-implemented method for facilitating a selectable presentation point in a message list, where sorting is inherently performed in connection with selection of a list access point selector. As in the case of the embodiment of FIG. 5, the flowchart of FIG. 6 and other flowcharts described herein may be, in various embodiments, implemented in software executable by a processor. At block 600, selection of a selector control initiation item is recognized. For example, the application may recognize the user's selection of a user interface item to present date/calendar access points. In response, a graphical selector control may be presented as depicted at block 602. In one embodiment, the graphical selector control includes graphically selectable access points based on a sorting criterion associated with the selected selector control initiation item. For example, a calendar graphical selector control may include days, months, and/or years that may be selected. Selection of a graphically selectable access point is recognized at block 604. At block 606, the presentation of the message list is adjusted to a position corresponding to the graphically selected access point as sorted based on the sorting criterion. Thus, in this embodiment, no sorting function is first explicitly conducted, but rather the sorting function is inherently performed in connection with presentation of the list portion based on the graphically selectable access point.

FIG. 7 is a flow diagram depicting a computer-implemented method for facilitating a selectable presentation point in a message list based on a calendar date. In this example, the message list presented on a display device is sorted by date as depicted at block 700. As noted at blocks 700A and 700B respectively, the message list may be presented in ascending order or descending order. At block 702, a graphical selector control is presented, which includes a vertically-oriented calendar with graphically selectable dates in this example. Selection of a graphically selectable date is recognized at block 704. The presentation of the message list is adjusted on the display device to a position corresponding to the graphically selected date as depicted at block 706. As noted at blocks 706A and 706B respectively, the adjusted presentation may be presented in ascending order, or in descending order, with the selected date at a determined location in the presentation, such as at the top of the presented list portion.

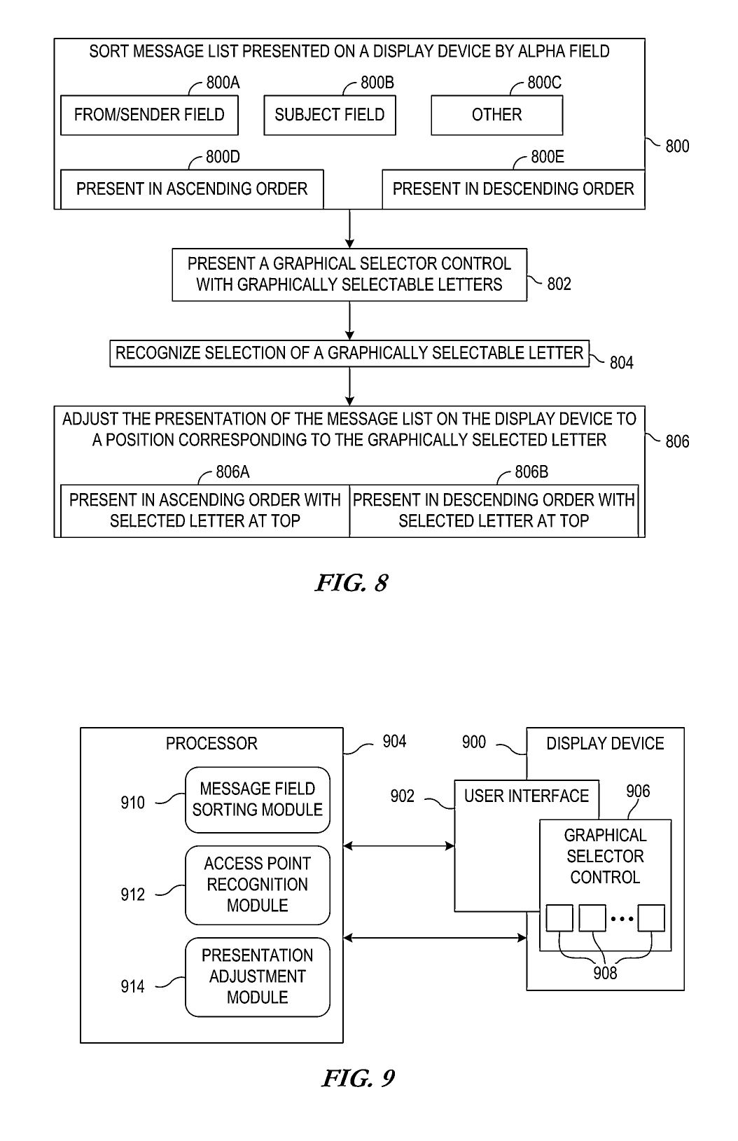

FIG. 8 is a flow diagram depicting a computer-implemented method for facilitating a selectable presentation point in a message list based on an alpha character(s). In this example, the message list presented on a display device is sorted by alphabetic letter of an alpha field as depicted at block 800. Representative alpha fields include, for example, a from/sender field 800A, subject field 800B or other field 800C involving alpha characters. As noted at blocks 800D and 800E, the message list may be presented in ascending order or descending order. At block 802, a graphical selector control is presented, which includes graphically selectable letters or other indicia representative of letter/character locations in the list. Selection of a graphically selectable letter is recognized at block 804. The presentation of the message list is adjusted on the display device to a position corresponding to the graphically selected letter as depicted at block 806. As noted at blocks 806A and 806B respectively, the adjusted presentation may be presented in ascending order, or in descending order, with the message associated with the selected letter at a determined location in the presentation, such as at the top of the presented list portion.

FIG. 9 is a block diagram of a representative apparatus facilitating a selectable presentation point in a message list in accordance with the disclosure. The illustrated embodiment includes at least a display 900, user interface 902 and processor(s) 904. In one embodiment, the user interface 902 is configured to facilitate selection of a graphical selector control 906 having a plurality of graphically selectable access points 908 relating to a message field of messages in a message list. The user interface 902 may further be configured to facilitate selection of at least one of the graphically selectable access points for the message field. The illustrated user interface 902 is implemented at least in part by a graphical user interface operable via the display 900. A processor(s) 904 is coupled to the display 900 and user interface 902, and is configured to adjust a presentation of the message list on the display 900 to a position corresponding to one of the selected graphically selectable access points 908 and sorted by the message field. For example, a message field sorting module 910 may include programming code executable by the processor 904 to sort the presented list portion by a selected message field. The access point recognition module 912 may include programming code executable by the processor 904 to recognize which of the access points 908 has been selected by the user. The presentation adjustment module 914 may include programming code executable by the processor 904 to adjust the point in the message list that is presented, based on at least the selected access point 908.

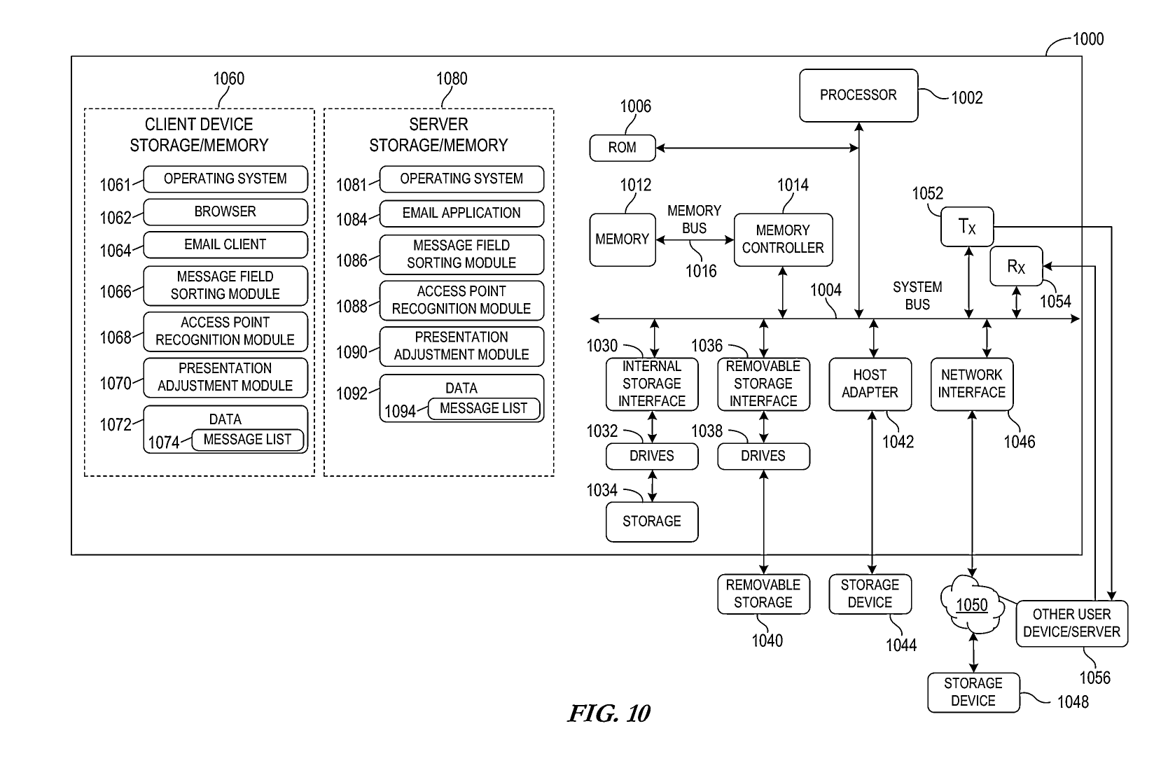

FIG. 10 depicts a representative computing system 1000 in which principles described herein may be implemented. The representative computing system 1000 can represent any of the computing/communication devices described herein, such as, for example, a client device, web-based message server, etc. The computing environment described in connection with FIG. 10 is described for purposes of example, as the structural and operational disclosure for facilitating a graphically selectable presentation point in a message list is applicable in any environment in which messages or other digital content may be listed in an order or sequence. It should also be noted that the computing arrangement of FIG. 10 may, in some embodiments, be distributed across multiple devices.

For both client devices and servers, the representative computing system 1000 may include a processor 1002 coupled to numerous modules via a system bus 1004. The depicted system bus 1004 represents any type of bus structure(s) that may be directly or indirectly coupled to the various components and modules of the computing environment. A read-only memory (ROM) 1006 may be provided to store, for example, firmware used by the processor 1002. The ROM 1006 represents any type of read-only memory, such as programmable ROM (PROM), erasable PROM (EPROM), or the like.

The host or system bus 1004 may be coupled to a memory controller 1014, which in turn is coupled to the memory 1012 via a memory bus 1016. The operational modules associated with the principles described herein may be stored in and/or utilize any storage, including volatile storage such as memory 1012, as well as non-volatile storage devices. FIG. 10 illustrates various other representative storage devices in which applications, modules, data and other information may be temporarily or permanently stored. For example, the system bus may be coupled to an internal storage interface 1030, which can be coupled to a drive(s) 1032 such as a hard drive. Storage 1034 is associated with or otherwise operable with the drives. Examples of such storage include hard disks and other magnetic or optical media, flash memory and other solid-state devices, etc. The internal storage interface 1030 may utilize any type of volatile or non-volatile storage.

Similarly, an interface 1036 for removable media may also be coupled to the bus 1004. Drives 1038 may be coupled to the removable storage interface 1036 to accept and act on removable storage 1040 such as, for example, floppy disks, optical disks, memory cards, flash memory, external hard disks, etc. In some cases, a host adaptor 1042 may be provided to access external storage 1044. For example, the host adaptor 1042 may interface with external storage devices via small computer system interface (SCSI), Fibre Channel, serial advanced technology attachment (SATA) or eSATA, and/or other analogous interfaces capable of connecting to external storage 1044. By way of a network interface 1046, still other remote storage may be accessible to the computing system 1000. For example, wired and wireless transceivers associated with the network interface 1046 enable communications with storage devices 1048 through one or more networks 1050. Storage devices 1048 may represent discrete storage devices, or storage associated with another computing system, server, etc. Communications with remote storage devices and systems may be accomplished via wired local area networks (LANs), wireless LANs, and/or larger networks including global area networks (GANs) such as the Internet.

User/client devices, email servers, or other devices can communicate information therebetween. For example, communication of a message list from an email server to a client device can be effected by direct wiring, peer-to-peer networks, local infrastructure-based networks (e.g., wired and/or wireless local area networks), off-site networks such as metropolitan area networks and other wide area networks, global area networks, etc. A transmitter 1052 and receiver 1054 are shown in FIG. 10 to depict the representative computing system's structural ability to transmit and/or receive data in any of these or other communication methodologies. The transmitter 1052 and/or receiver 1054 devices may be stand-alone components, may be integrated as a transceiver(s), may be integrated into or already-existing part of other communication devices such as the network interface 1046, etc.

As computing system 1000 can be implemented at a client device, email server, etc., block 1056 represents the other devices/servers that communicate with the communicating system 1000 when it represents one of the devices/servers. In addition to operating systems and other software/firmware that may be implemented in each of the user devices or message servers, each may include software modules operable by the processor 1002 executing instructions. Some representative modules for each of a number of representative devices/servers are described below.

When the device 1000 represents a user or client device, the client device storage/memory 1060 represents what may be stored in memory 1012, storage 1034, 1040, 1044, 1048, and/or other data retention devices of a client device such as a computer, smartphone, laptop computer, etc. The representative client device storage/memory 1060 may include an operating system 1061, and processor-implemented functions represented by functional modules. For example, a browser 1062 and/or email client 1064 may be provided. The browser 1062 may be used to access a web-based email or other message application executing on a remote host computing system. Other modules previously discussed in connection with the previous figures may also be provided in the storage/memory 106 of the client device, such as a message field sorting module 1066 for sorting messages by field, an access point recognition module 1068 to identify access points selected by a user, a presentation adjustment module 1070 to adjust the message list presentation based on the selected access points, etc. Data 1072 may also be stored, such as the message list 1074 itself.

Where the representative computing system 1000 represents an email server or other network service as described herein, the memory 1012 and/or storage 1034, 1040, 1044, 1048 may be used to store programs and data used in connection with the server's functional operations previously described. The server storage/memory 1080 represents what may be stored in memory 1012, storage 1034, 1040, 1044, 1048, databases, and/or other data retention devices at an email server or other network service node. The representative server storage/memory 1080 may include, for example, an operating system 1081 and a web-based email application 1084. Various modules described herein may be hosted by the email server and stored in the server storage/memory 1080, or may have shared operations with the client device. Thus, in one embodiment, an email server or other server storage/memory 1080 may include a message field sorting module 1086, access point recognition module 1088, presentation adjustment module 1090, etc. Data 1092 may also be stored at the storage/memory 1080, and in one embodiment the message list 1094 is stored at the server, such as when the client device accesses email via a browser 1062. The modules described above may be implemented via software and/or firmware, and executed by the processor 1002 at the respective client/server device.

As previously noted, the representative computing system 1000 in FIG. 10 is provided for purposes of example, as any computing device having processing and communication capabilities can carry out the functions described herein using the teachings described herein. It should also be noted that the sequence of various functions in the flow diagrams or other diagrams depicted herein need not be in the representative order that is depicted unless otherwise noted.

As demonstrated in the foregoing examples, methods are described that can be executed on a computing device, such as by providing software modules that are executable via a processor (which includes a physical processor and/or logical processor, controller, etc.). The methods may also be stored on computer-readable media that can be accessed and read by the processor and/or circuitry that prepares the information for processing via the processor. For example, the computer-readable media may include any digital storage technology, including memory 1012, storage 1034, 1040, 1044, 1048, any other volatile or non-volatile digital storage, etc. Having instructions stored on a computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained.

Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. A computer-implemented method comprising:
sorting a message list presented on a display device based on at least one sorting criterion designated via a graphical user interface;
presenting a graphical selector control having a plurality of graphically selectable access points based on the at least one designated sorting criterion;
recognizing selection of one of the graphically selectable access points; and
adjusting a presentation of the message list on the display device to a position corresponding to the graphically selected access point.

2. The computer-implemented method of claim 1, wherein:
sorting the message list comprises sorting the message list based on a receipt date of each message;
presenting a graphical selector control comprises presenting a graphical calendar selector control having a calendar navigable by at least day, month and year; and
recognizing selection of one of the graphically selectable access points comprises recognizing selection of one of the days of the calendar.

3. The computer-implemented method of claim 2, wherein presenting a graphical calendar selector control comprises presenting a vertically-oriented graphical calendar selector control having a calendar navigable month-to-month by scrolling up or down.

4. The computer-implemented method of claim 1, wherein:
sorting the message list comprises sorting the message list based on a message field capable of being sorted by letter;
presenting a graphical selector control comprises presenting a graphical alpha selector control having a plurality of selectable letters; and
recognizing selection of one of the graphically selectable access points comprises recognizing selection of one of the selectable letters.

5. The computer-implemented method of claim 1, wherein presenting the presenting a graphical selector control comprises presenting the presenting a graphical selector control in response to invoking a triggering user interface mechanism after the message list has been sorted.

6. The computer-implemented method of claim 1, wherein presenting the presenting a graphical selector control comprises presenting the presenting a graphical selector control in response to sorting the message list.

7. The computer-implemented method of claim 1, wherein sorting a message list comprises sorting the message list in descending order, and wherein adjusting a presentation of the message list comprises adjusting the presentation of the message list with a first message corresponding to the graphically selected access point positioned at the top of the presentation, and preceding messages in the message list presented below the first message.

8. The computer-implemented method of claim 1, wherein sorting a message list comprises sorting the message list in ascending order, and wherein adjusting a presentation of the message list comprises adjusting the presentation of the message list with a first message corresponding to the graphically selected access point positioned at the top of the presentation, and subsequent messages in the message list presented below the first message.

9. An apparatus comprising:
a display;
a user interface configured to facilitate selection of a graphical selector control having a plurality of graphically selectable access points relating to a message field of messages in a message list, and configured to facilitate selection of at least one of the graphically selectable access points for the message field; and
a processor configured to adjust a presentation of the message list on the display to a position corresponding to the selected graphically selectable access point and sorted by the message field.

10. The apparatus of claim 9, wherein:
the user interface is configured to facilitate selection of a graphical calendar selector control having a plurality of graphically selectable dates relating to a message receipt date of the messages in the message list, and configured to facilitate selection of at least one of the graphically selectable dates for the message receipt date; and
the processor is configured to adjust the presentation of the message list on the display to a position corresponding to the selected graphically selectable date and sorted by the message receipt date.

11. The apparatus of claim 10, wherein the user interface is further configured to present the graphical calendar selector control in a vertical month-to-month orientation.

12. The apparatus of claim 9, wherein:
the user interface is configured to facilitate selection of a graphical character selector control having a plurality of graphically selectable characters relating to an alphabetic field of the messages in the message list, and configured to facilitate selection of at least one of the graphically selectable characters for the alphabetic field; and
the processor is configured to adjust the presentation of the message list on the display to a position corresponding to the selected graphically selectable character and sorted by the alphabetic field.

13. The apparatus of claim 9, wherein:
the user interface is further configured to facilitate identification of selection of the message field; and
the processor is configured to recognize the identified message field, and configured to adjust the presentation of the message list on the display to a position corresponding to the selected graphically selectable access point and sorted by the recognized message field.

14. The apparatus of claim 9, wherein the processor is configured to identify the message field based on a selected one of the graphical selector controls, and configured to adjust the presentation of the message list on the display to a position corresponding to the selected graphically selectable access point and sorted by the identified message field.

15. The apparatus of claim 14, wherein the user interface is further configured to provide a plurality of the graphical selector controls, each corresponding to a different message field of the messages in the message list.

16. The apparatus of claim 9, wherein:
the user interface is configured to facilitate selection of a graphical character selector control having a plurality of graphically selectable message sizes relating to a storage size of the messages in the message list, and configured to facilitate selection of at least one of the graphically selectable message sizes; and
the processor is configured to adjust the presentation of the message list on the display to a position corresponding to the selected graphically selectable message size and sorted by the storage size.

17. The apparatus of claim 9, wherein:
the user interface is configured to facilitate selection of a graphical character selector control having a plurality of graphically selectable icons relating to message types of the messages in the message list, and configured to facilitate selection of at least one of the graphically selectable icons; and
the processor is configured to adjust the presentation of the message list on the display to a position corresponding to the selected graphically selectable icons and sorted by the message types.

18. Computer-readable media having instructions stored thereon which are executable by a processor for performing functions comprising:
sorting an email list presented on a display based on a receive date of each email in the email list;
receiving an indication to invoke a graphical calendar selector control;
in response to receiving the indication, presenting the graphical calendar selector control having a vertically-navigable, month-to-month calendar with graphically selectable dates;
receiving a selection indication for a selected one of the graphically selectable dates; and
adjusting a presentation of the email list on the display to present an email corresponding to the selected one of the graphically selectable dates at the top of the presentation of the email list.

19. The computer-readable media as in claim 18, further comprising instructions executable by the computing system for performing further functions comprising:
sorting the email list based on alphabetic characters in an alpha field of each email in the email list;
receiving a second indication to invoke a graphical alpha selector control;
in response to receiving the second indication, presenting the graphical alpha selector control with graphically selectable letters;
receiving a second selection indication for a selected one of the graphically selectable letters; and
adjusting the presentation of the email list on the display to present an email corresponding to the selected one of the graphically selectable letters at the top of the presentation of the email list.

20. The computer-readable media as in claim 18, wherein the instructions for adjusting the presentation of the email list on the display comprise instructions for adjusting the presentation of the email list on the display to present the email having a receive date closest to the selected one of the graphically selectable dates at the top of the presentation of the email list.
